(19) United States
(12) Patent Application Publication
(10) Pub. No.: US 2017/0142351 A1
(43) Pub. Date: May 18, 2017

(54) DUAL BAND FILTERS AND DETECTORS

(71) Applicant: Honeywell International Inc., Morris Plains, NJ (US)

(72) Inventors: Barrett E. Cole, Bloomington, MN (US); Bernard S. Fritz, Eagan, MN (US)

(21) Appl. No.: 15/356,297

(22) Filed: Nov. 18, 2016

Related U.S. Application Data
(60) Provisional application No. 62/257,056, filed on Nov. 18, 2015.

(51) Int. Cl. H04N 5/33; G02B 5/20

(52) U.S. Cl. CPC H04N 5/33; G02B 5/208

(57) ABSTRACT

Dual band filters and detectors are described herein. A detector can include a filter for filtering light from a scene to be imaged, the filter having at least one window that only allows light to pass there through that is within a medium wavelength infrared wavelength range and at least one window that allows light to pass there through that is not within a medium wavelength infrared wavelength range and an imager array that receives the filtered light that passes through the filter.

### TECHNICAL FIELD

The present disclosure relates to devices, systems, and methods for creating and utilizing a dual band filters and detectors.

### BACKGROUND

It is desirable to detect flames for early alarming of a fire. A typical method is that of triple-infrared (IR) which involves three detectors: one tuned to the 4.4 μm carbon dioxide emission band line, that is formed when hydrocarbons burn, and the other two tuned to off-band lines, to discriminate between a flame and hot objects. These sensors typically look at a 90 degree field of view, but are not capable of discerning individual sources of light within that field of view.

Another approach is to use an imager so that the camera can better discriminate between a flame and hot objects within the field of view. An imager makes it possible to see flames even when there are other hot objects in the field of view that are in different locations.

However, there are several potential problems with such a solution. For example, in some instances, the optics may get coated or an object may be in the way of the field of view. This can impair the viewing of a flame and/or its identification.

It is also desirable to look at objects in the field of view and discern whether these objects are emitted at 4.4 μm which may be an indicator of a flame, rather than just a hot item in the field of view. To do this currently requires the use of a filter, but the moving parts associated with such filters can lead to failure.

### BRIEF DESCRIPTION OF THE DRAWINGS

FIG. 1 illustrates a dual array imager in accordance to one or more embodiments of the present disclosure.

FIG. 2 illustrates examples of array image options in accordance with one or more embodiments of the present disclosure.

FIG. 3 illustrates an optical design of a dual array imager in accordance to one or more embodiments of the present disclosure.

FIG. 4A illustrates a graph of the transmission of a bolometer package imager window that allows medium and long wavelength infrared light to be received by a dual array imager in accordance to one or more embodiments of the present disclosure.

FIG. 4B illustrates a graph of a filter pixel profile that transmits medium wavelength infrared light to be received by a dual array imager in accordance to one or more embodiments of the present disclosure.

FIG. 5A illustrates a graph of a filter pixel profile that transmits long wavelength infrared light to be received by a dual array imager in accordance to one or more embodiments of the present disclosure.

FIG. 5B illustrates a graph of a filter profile that transmits medium wavelength infrared light to be received by a dual array imager in accordance to one or more embodiments of the present disclosure.

FIG. 6 illustrates graphs of long wavelength infrared light on the left and medium wavelength infrared light on the right received by a dual array imager in accordance to one or more embodiments of the present disclosure.

FIG. 7A illustrates a visible image of a refinery fire.

FIG. 7B illustrates a combined medium and long wavelength infrared image created by a dual array imager in accordance to one or more embodiments of the present disclosure.

FIG. 7C illustrates a long wavelength infrared image created by a dual array imager in accordance to one or more embodiments of the present disclosure.

FIG. 7D illustrates a medium wavelength infrared image created by a dual array imager in accordance to one or more embodiments of the present disclosure.

FIG. 8 illustrates a top image combining alternating medium and long wavelength infrared image components created by a dual array imager in accordance to one or more embodiments of the present disclosure with a left lower image showing the long wavelength component, and the right lower image showing the medium wavelength component.

### DETAILED DESCRIPTION

Flame detector devices, systems, and methods using a dual band flame detector are described herein. The embodiments of the present disclosure provide an alternative to the above concepts.

In these embodiments, the detector uses a pixelated filter that contains alternating medium wavelength infrared (MWIR) and long wavelength infrared (LWIR) window regions. This structure images the filter design onto a sensor array (e.g., microbolometer) that can be used to sense both medium wavelength infrared and long wavelength infrared radiation.

This can be accomplished, for example, by having every other pixel in the focal plane array alternate between filtering to allow MWIR to pass through and filtering to allow LWIR to pass through or some arrangement of MWIR and LWIR radiation pixels as determined by a pixelated filter wherein each pixel is filtered to only allow MWIR or LWIR radiation to pass through to the array. This will lead to reduced spatial resolution of both the medium wavelength infrared and long wavelength infrared radiation images. However, with respect to an application for the identification of a flame, a user of a device for doing such sensing is typically looking for large objects that are much larger than one pixel and so the loss of resolution in such an implementation poses no problem, in such applications.

In some embodiments, by using an uncooled bolometer camera, it is possible through such implementations using the LWIR band, for example, with thermal imaging to see if the common lens element is coated with oil or water. Thus, it can be determined whether the camera has been compromised by such elements and service is needed to bring the camera back into operational condition.

It is also possible to look at a nearby pixel in a different wave band and, since the image of a flame will include more than one pixel, it is possible, by measuring the relative intensities of the two images, to observe whether it is a thermal source or a flame source.

It is also possible to use the camera for night vision applications ranging from surveillance to determining if a person is in the vicinity of a flame. Some camera embodiments of the present disclosure can be used to function twenty-four hours a day without the need for moving parts and without external lighting which can be beneficial in some applications.

In embodiments of the present disclosure, a lens-pixelated filter assembly can be part of a flame detector that is capable of night vision with the LWIR band and observing flames in the MWIR band without any moving parts. In addition, it is able, through changes in the thermal image, to determine if the imagery is being blocked, if the lens is being coated with oil, water, or otherwise degraded 24 hours a day. In addition, such a camera with LWIR capability is able to see people and other thermal objects in the field of view (FOV) for safety, surveillance, and threat avoidance.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure, and should not be taken in a limiting sense.

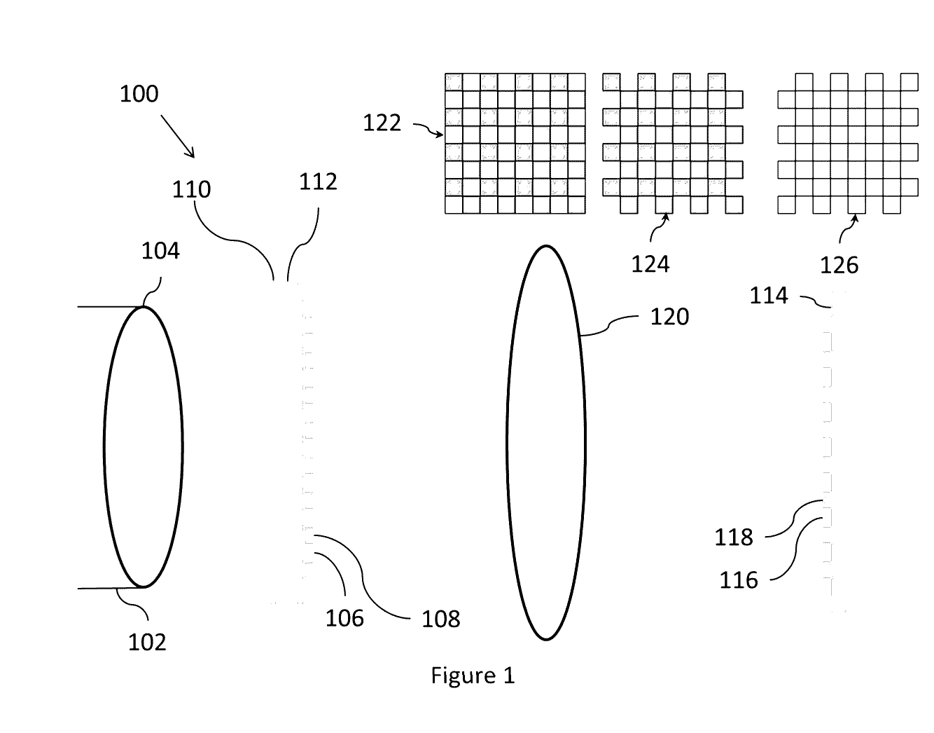

Directional terms such as “horizontal” and “vertical” “above” and “below” are used with reference to the component orientation depicted in FIG. 1. These terms are used for example purposes only and are not intended to limit the scope of the appended claims.

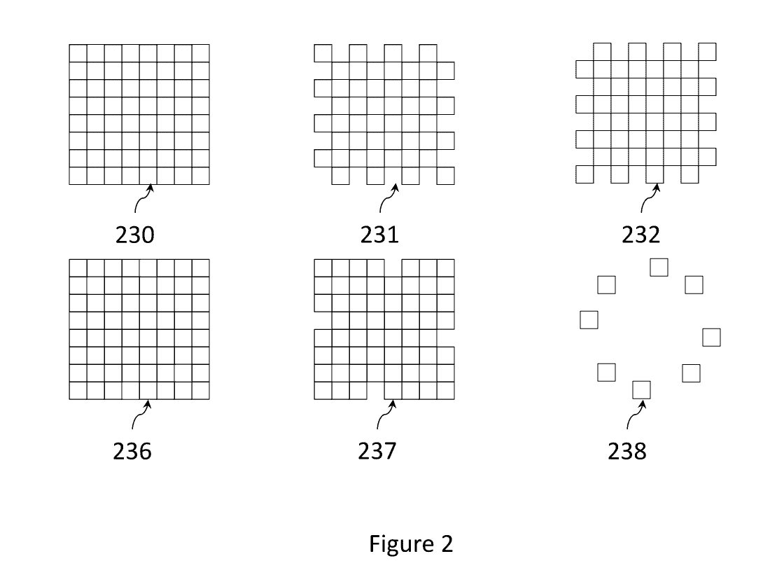

The figures herein follow a numbering convention in which the first digit or digits correspond to the drawing figure number and the remaining digits identify an element or component in the drawing. Similar elements or components between different figures may be identified by the use of similar digits. For example, 100 may reference element “00” in FIG. 1, and a similar element may be reference as 200 in FIG. 2.

As used herein, “a” or “a number of” something can refer to one or more such things. For example, “a number of spacers” can refer to one or more spacers.

FIG. 1 illustrates a dual array imager in accordance to one or more embodiments of the present disclosure. As discussed above, in some embodiment, the detector 100 uses a pixelated filter that contains alternating MWIR and LWIR window regions.

In the example embodiment of FIG. 1, light 102 enters the imager from the left side of FIG. 1 and passes through a lens 104. The light then passes through a filter 112 having alternating medium wavelength infrared (3000-5000 nm) 106 and long wavelength infrared (above a threshold of 5000 nm) 108 window regions. In some embodiments, a long wavelength range can be defined as within a wavelength range of 5000 to 14000 nm.

Such a structure can, for example, be formed on a silicon substrate and, can have an argon coating 110 thereon, in some embodiments. Further, in some embodiments, the light impinging on the filter can have a focal point at the layer of the filter in which one or more of the windows 106 and 108 are positioned.

The structure of FIG. 1 then allows light to pass through a lens 120. This lens can be used to better arrange the light for its contact with a microbolometer array 114 as discussed below.

A structure, as shown in FIG. 1, can be used to image the light patterned in the filter design onto a microbolometer array 114. The microbolometer array can be used to sense both medium wavelength infrared and long wavelength infrared radiation, which can be used in flame detection a discussed in more detail below.

In some embodiments, such as that shown in FIG. 1, due to this filter design, every other pixel in the focal plane array alternates between medium wavelength infrared 116 and long wavelength infrared 118 radiation pixels. In other words, the determination of whether a pixel on the imaging array is an LWIR or MWIR pixel is determined based on the light that pixel receives and the window in the filter that the light that passes through that contacts that particular pixel.

Other MWIR/LWIR filter designs can be used in embodiments of the present disclosure and may have other benefits based on the application in which they are used. For example, some other arrangements of medium wavelength infrared and long wavelength infrared radiation pixels are illustrated in FIG. 2. These designs are determined by the pixelated filter 112 being used for imaging medium wavelength infrared and long wavelength infrared radiation (due to their arrangement to receive light from adjacent spots in a scene being captured).

Such techniques will lead to reduced spatial resolution of both the medium wavelength infrared and long wavelength infrared radiation images, but allows imaging in both ranges simultaneously and from the same viewpoint (that of the imager array capturing both ranges).

However, with respect to identification of a flame application one is looking for large objects that are much larger than one pixel and so the loss of resolution poses no problem, in such applications.

FIG. 2 illustrates examples of array image options in accordance with one or more embodiments of the present disclosure. In FIG. 2, the upper left filter design 230 will provide an image having both medium wavelength and long wavelength components. This will provide the viewer of the image with both MWIR and LWIR, image information that can identify a flame and background image information that can be used, for example, to determine the location of the flame with respect to other items in the images (landmarks that can be used to locate the flame).

In this embodiment, the left upper filter design 230 illustrates a composite filter including the two image filter components shown separated in the upper center design 231 and upper right design 232.

The upper right filter design 232 provides only medium wavelength components (allows MWIR to pass through its windows) and can be used to identify the presence of a flame within the view of the imager. The upper center filter design 231 provides only long wavelength components (allows LWIR to pass through its windows) that can be used to check operability of the flame detection system and/or general operability of the elements within the view of the imager.

The lower filter design concept illustrates another alternative embodiment that may be suitable for some applications. In this design, there are more medium wavelength windows and less long wavelength windows allowing for a more complete medium wavelength image, but still having some long wavelength components that can be used for location context and general operability. This can be beneficial in situations where flame detection may be a higher priority than location context and general operability or where only a few pixels would be needed to identify a location within the view of the imager.

In the embodiment illustrated in the lower set of filter design elements, the left lower filter design 236 illustrates a composite filter including the two image filter components shown separated in the lower center design 237 and lower right design 238.

In some embodiments, a filter design could have less medium wavelength windows and more long wavelength windows (comparing the LWIR windows of 237 with the greater number of MWIR windows in 238). allowing for a more complete long wavelength image, but still having some medium wavelength components that can be used for flame detection. Such embodiments could, for example be used where the image of the area is more important than flame detection or where an image will only possibly be present in a few locations in the view of the imager and, therefore, the filter can be designed to use medium wavelength in those particular areas of the view of the imager.

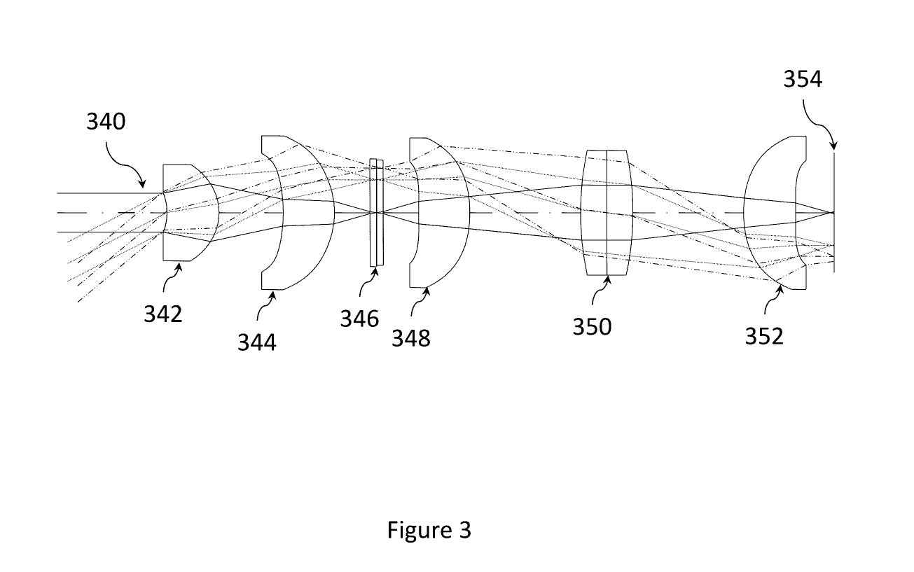

FIG. 3 illustrates an optical design of a dual array imager in accordance to one or more embodiments of the present disclosure. In the embodiment shown in FIG. 3, various optical elements are shown. However, the embodiments of the present disclosure are not so limited.

In the embodiment of FIG. 3, light 340 enters the structure from the left side of the picture. The light passes through two lenses 342 and 344 and then contacts the pixelated array 346 which filters the light as discussed above, into medium wavelength and long wavelength components. The light then continues through the structure, passing through three other sets of lenses 348, 350, and 352 that arrange the light for contact with the sensing array 354 on the right side of the picture.

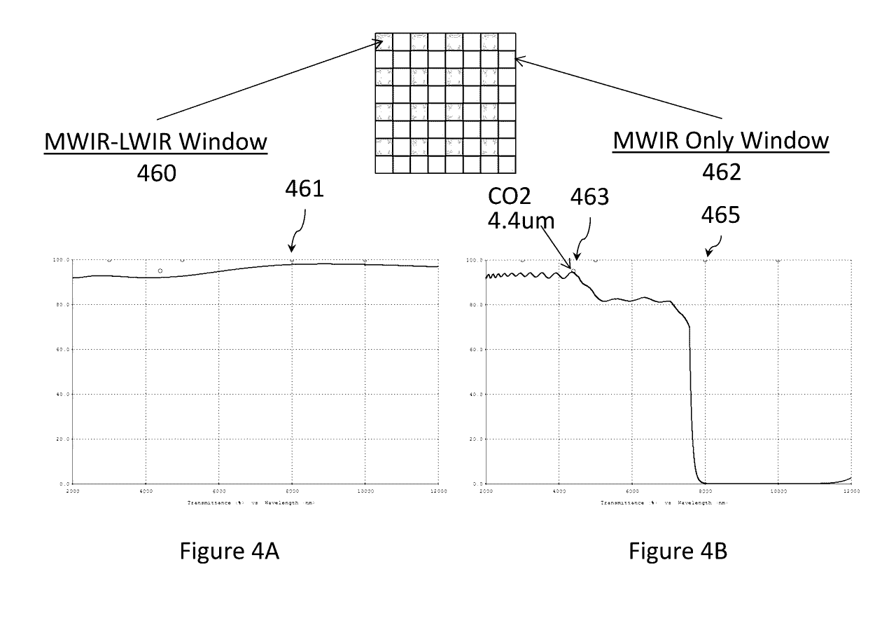

FIG. 4A illustrates a graph of the transmission of a bolometer package imager window that allows medium and long wavelength infrared light to be received by a dual array imager in accordance to one or more embodiments of the present disclosure. In the FIG. 4A, the graph shows the transmittance versus the wavelength of the light sensed by a sensor array when an alternating filter design (as illustrated at the top of the figure), having both MWIR and LWIR components passing through half of the windows 460 and MWIR only passing through filter windows 462, is used. In this example, it illustrates that the transmittance is near 100% (the top of the chart) even though some of the light has been filtered due to the alternating filter design and that the lower transmittance is in the medium wavelengths of between 2000 (left edge of the graph) and 8000 nm at 461.

In contrast, FIG. 4B illustrates a graph of a filter pixel profile that transmits only medium wavelength infrared light to be received by a dual array imager in accordance to one or more embodiments of the present disclosure. In this illustration, when only the medium wavelength components are utilized, the graph shows high transmittance in the medium wavelengths between 2000 (left edge of the graph) and 8000 nm at 465 and no transmittance above 8000 nm at 465. In the embodiment described in the graph, the transmittance is particularly good from 2000 to about 4400 nm and then drops off between 4400 and 8000 nm, but still has over 80% transmittance.

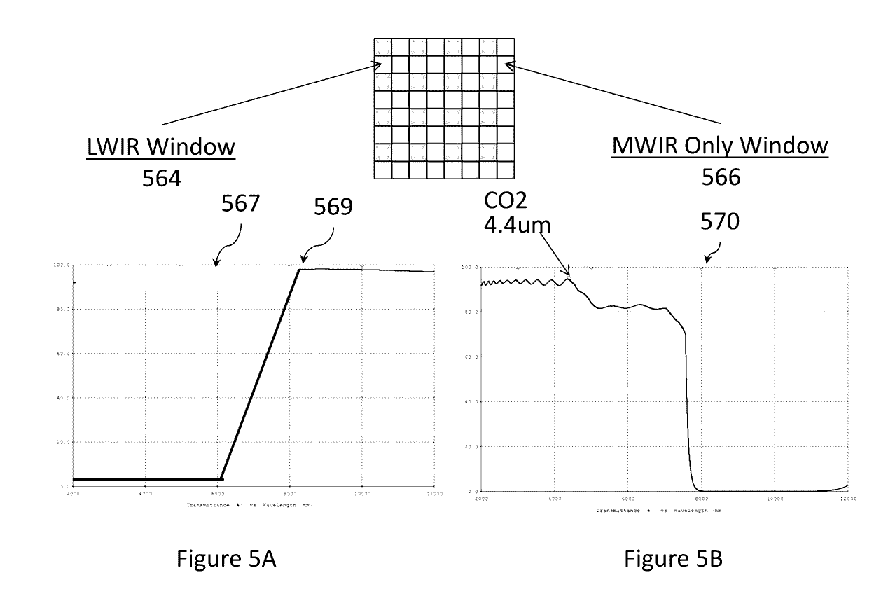

FIG. 5A illustrates a graph of a filter pixel profile that transmits long wavelength infrared light to be received by a dual array imager in accordance to one or more embodiments of the present disclosure. In this illustration, when only the long wavelength components 564 are utilized, the graph shows high transmittance in the long wavelengths above 8200 at 569 nm, no transmittance between 2000 and 6000 nm, and increasing transmittance between 6000 at 567 and 8200 nm.

FIG. 5B illustrates a graph of a filter profile that transmits medium wavelength infrared light through windows 566 to be received by a dual array imager in accordance to one or more embodiments of the present disclosure. In this illustration, as with the illustration of FIG. 4B, when only the medium wavelength components are utilized, the graph shows high transmittance in the medium wavelengths between 2000 and 7600 nm and no transmittance above 8000 nm at 570.

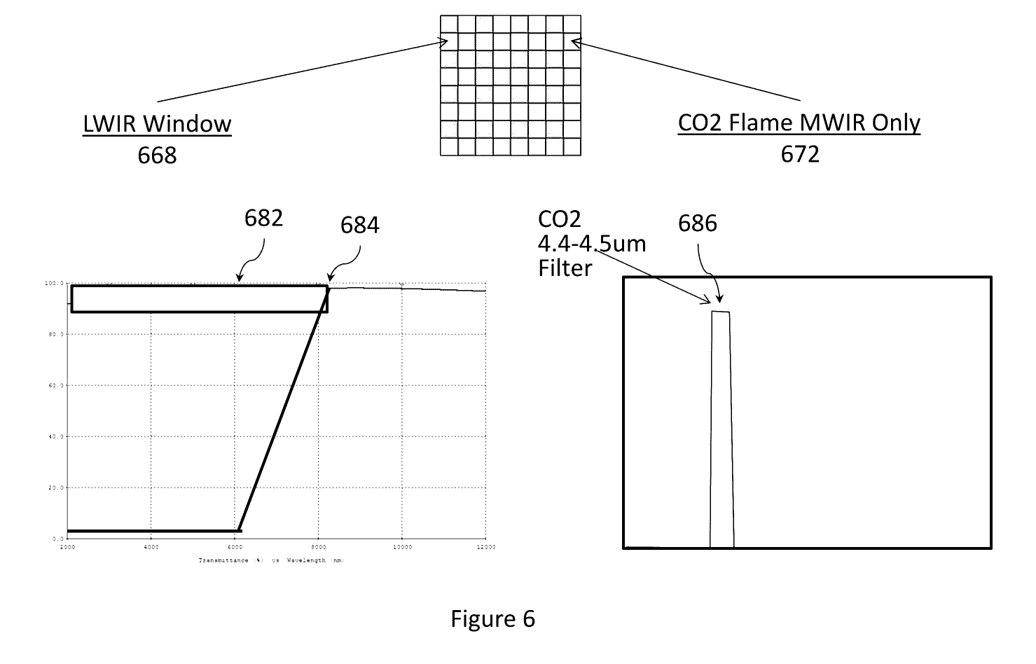

FIG. 6 illustrates graphs of filter profiles that transmit long wavelength infrared light on the left and medium wavelength infrared light on the right to be received by a dual array imager in accordance to one or more embodiments of the present disclosure. In the embodiment of FIG. 6, the graph on the left illustrates that the long pass filtering window elements 668 are filtering light below 6000 nm at 682 and are nearly 100% transmissive to light over 8000 nm as shown at 684. In the graph on the right, the filter is specifically design to identify a CO₂ signature. In this embodiment, the filter has low transmittance through windows 672 in all wavelengths except those around the wavelength of a CO₂ flame (i.e., 4400 nm to 4500 nm identified at 686, in the illustrated example).

As such, embodiments of the present disclosure can allow for identification of flames having specific chemical compositions and, in some embodiments, the filter bandpass wavelength can be designed to be adjusted to allow identification on a single chemical signature of a particular type of flame, such as emission around 2.7 um for an H₂ flame.

This can be accomplished by identifying the wavelength signature of the flame type and then creating a filter with windows that filter out all but a range of wavelengths near that wavelength signature. For example, if the signature of the desired chemical to be identified is 2700 nm, then the filter can be designed to filter out all wavelengths above or below 2700 nm outside a threshold of 100 nm (thereby allow only light that is within a threshold quantity of a wavelength of a particular chemical signature to pass through the window of the filter). The threshold can be any suitable quantity from the wavelength signature.

For example, in some embodiments, a filter body can have a set of windows (one or more windows) only allowing light to pass there through that is within a medium wavelength infrared wavelength range. In some such embodiments, the set of windows only allow light that is within a threshold distance of a wavelength of a particular wavelength (e.g., 4400 nm for CO₂, 2700 nm for H₂, etc.) as discussed above.

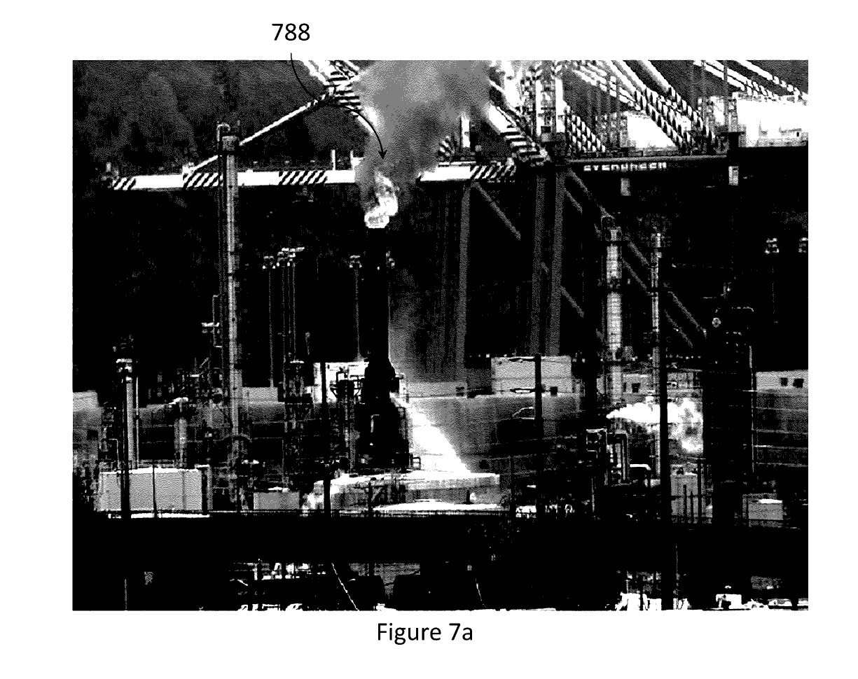

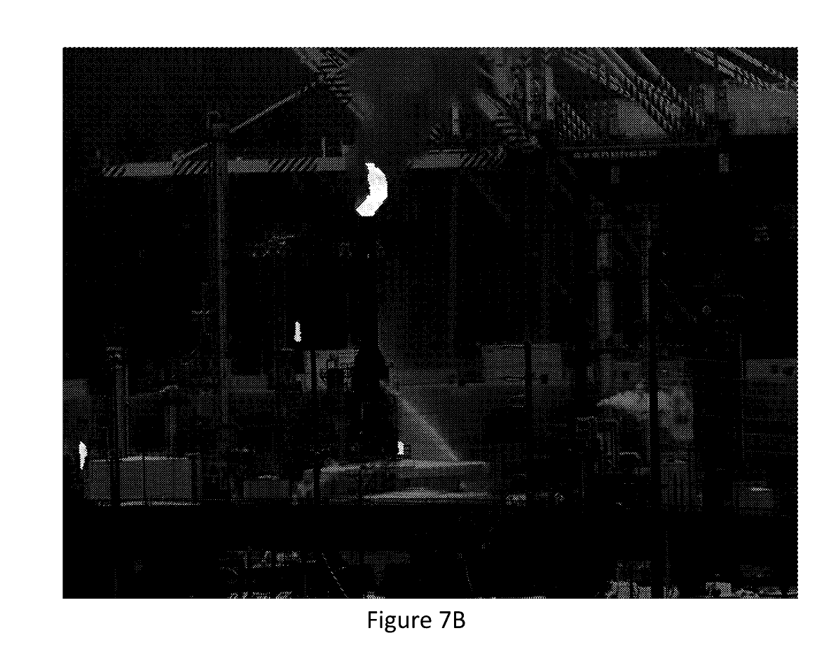

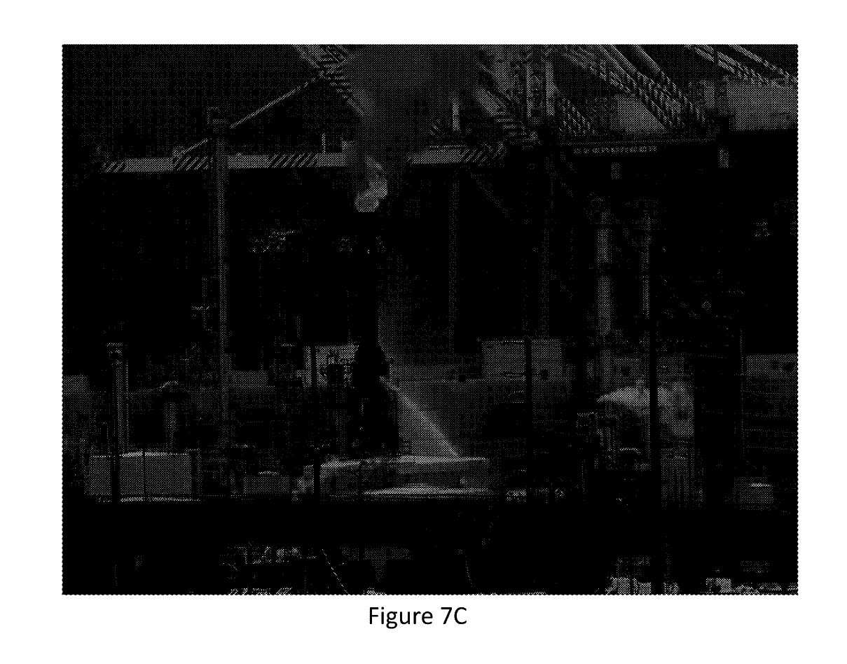

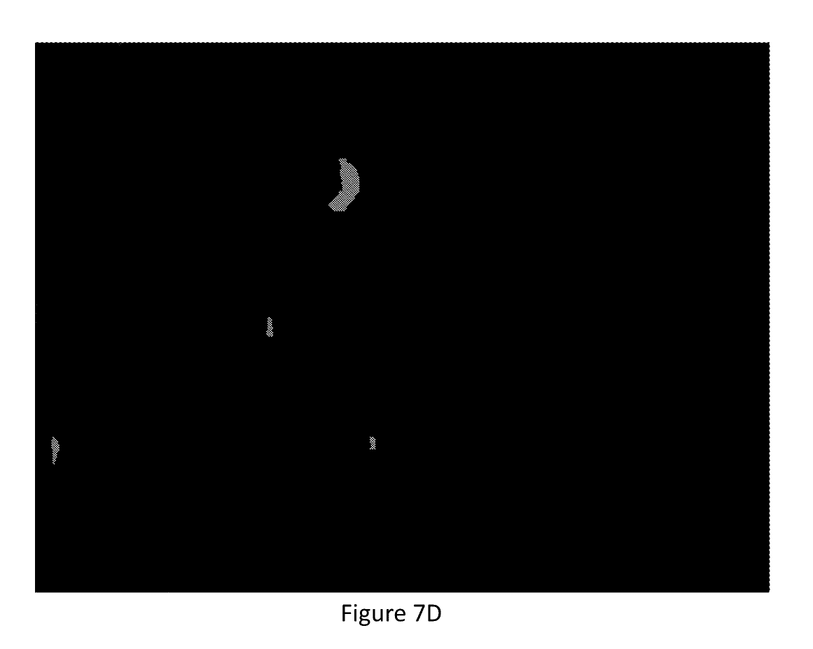

FIG. 7A illustrates a visible image of a refinery fire. This image represents an image taken by a normal camera that receives light in all wavelengths. As can be seen by this photo, the flame 788 and background have a similar level of intensity and definition in this image.

FIG. 7B illustrates a combined medium and long wavelength infrared image created by a dual array imager in accordance to one or more embodiments of the present disclosure. In this image, the pixels are alternated between medium and long wavelengths. As can be seen from this image, the long wavelength elements appear less defined and noticeable and the medium wavelength (flame areas) are also less defined, but more noticeable. This type of embodiment can be beneficial where flame identification is needed, but where the location of the flame in context with other items in the view of the imager is also needed.

FIG. 7C illustrates a long wavelength infrared image created by a dual array imager in accordance to one or more embodiments of the present disclosure. In this image, an alternating wavelength filter is used, but only the long wavelength pixels are shown, as such, the medium wavelength elements have been filtered out. As a result, all of the pixels are appear less defined and noticeable as the medium wavelength pixels have been filtered out.

FIG. 7D illustrates a medium wavelength infrared image created by a dual array imager in accordance to one or more embodiments of the present disclosure. In this image, an alternating wavelength filter is used, but only the medium wavelength pixels are shown, as such, the long wavelength elements have been filtered out. As a result, all of the pixels appear less defined, but the medium wavelength pixels are much more noticeable as the long wavelength pixels have been filtered out. This type of embodiment can be beneficial where flame identification is needed, and where the location of the flame in context with other items in the view of the imager is not needed.

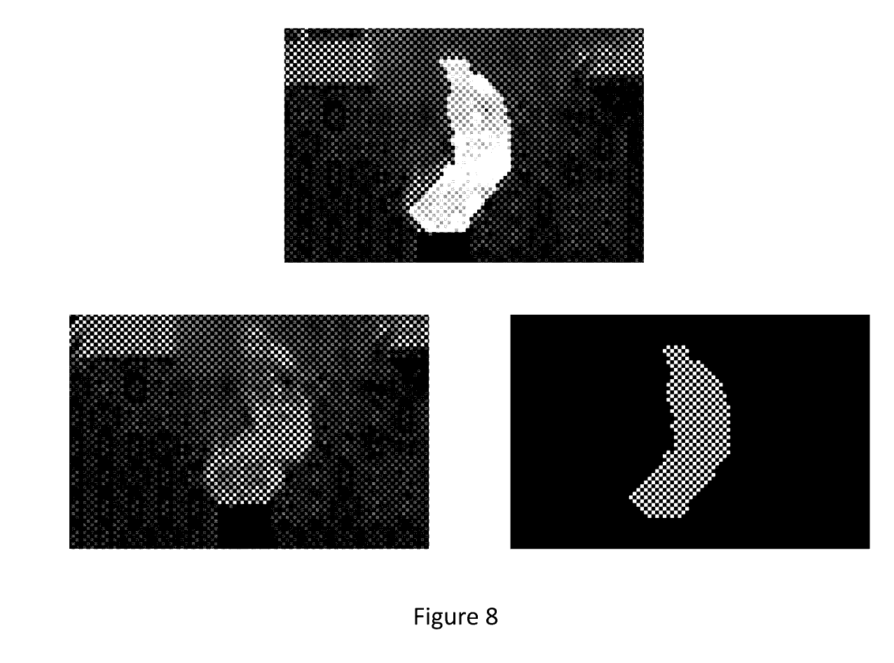

FIG. 8 illustrates a top image combining alternating medium and long wavelength infrared image components created by a dual array imager in accordance to one or more embodiments of the present disclosure with a left lower image showing the long wavelength component, and the right lower image showing the medium wavelength component. As can be seen by these three photos, the flame is more readily discernable from the alternating long wavelength infrared and medium wavelength infrared image and the medium wavelength infrared only image, than in the long wavelength only infrared image.

However, in the medium wavelength infrared only image, there is no background context to assist the viewer in knowing where the flame is located. So, this type of image may be beneficial in applications where the image is used to identify that a flame is present. Additionally, as this image can be created to have less image data, the use of such images can be accomplished on computing devices that are lower cost and/or have less processor and/or memory requirements.

In applications where the identification and location of the flame are to be used, the long wavelength infrared and medium wavelength infrared composite image can be beneficial as the long wavelength image components provide some context for determining the location of the flame with respect to other items in the view of the imager.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

1. A dual band detector, comprising:
a filter for filtering light from a scene to be imaged, the filter having at least one window that only allows light to pass there through that is within a medium wavelength infrared wavelength range and at least one window that allows light to pass there through that is not within a medium wavelength infrared wavelength range; and
an imager array that receives the filtered light that passes through the filter.

2. The detector of claim 1, wherein the at least one window that allows light to pass there through that is not within a medium wavelength infrared wavelength range allows only light that is within a long wavelength infrared range to pass there through.

3. The detector of claim 2, wherein the at least one window that allows light to pass there through that is within a long wavelength infrared wavelength range allows only light that is above a wavelength threshold of 5000 nm.

4. The detector of claim 3, wherein the at least one window that allows light to pass there through that is within a long wavelength infrared wavelength range allows only light that is within a wavelength range of 5000 to 14000 nm.

5. The detector of claim 1, wherein the at least one window that allows light to pass there through that is within a medium wavelength infrared wavelength range allows only light that is within a wavelength range of 3000 to 5000 nm.

6. The detector of claim 1, wherein the imager array includes multiple image sensors for receiving the filtered light.

7. The detector of claim 1, wherein the at least one window that allows light to pass there through that is within a medium wavelength infrared wavelength range allows only light that is within a threshold distance of a wavelength of a particular chemical signature.

8. A dual band detector, comprising:
a filter for filtering light from a scene to be imaged, the filter having a first set of windows that only allow light to pass there through that is within a medium wavelength infrared wavelength range and a second set of windows that allow light to pass there through that is not within a medium wavelength infrared wavelength range and wherein at least one of the first set of windows is adjacent at least one window of the second set of windows; and
an imager array that receives the filtered light that passes through the filter.

9. The detector of claim 1, wherein one of first set of windows is adjacent one window of the second set of windows and the one window of the second set of windows is adjacent a second window of the first set of windows.

10. The detector of claim 1, wherein a portion of the filter alternates in a first direction between windows of the first set and windows of the second set.

11. The detector of claim 10, wherein a portion of the filter alternates in a second direction between windows of the first set and windows of the second set.

12. A dual band filter for filtering light from a scene to be imaged, comprising:
a filter body;
at least a first window formed on the filter body, the window only allowing light to pass there through that is within a medium wavelength infrared wavelength range; and
at least a second window formed on the filter body, the second window allows light to pass there through that is not within a medium wavelength infrared wavelength range.

13. The dual band filter of claim 12, wherein the filter body has an argon coating provided thereon.

14. The dual band filter of claim 12, wherein the filter body includes a portion thereon through which light passes and wherein the portion has a surface area in which half of the surface area includes windows only allowing light to pass there through that is within a medium wavelength infrared wavelength range.

15. The dual band filter of claim 14, wherein the half of the surface area includes windows that allow light to pass there through that is not within a medium wavelength infrared wavelength range.

16. The dual band filter of claim 12, wherein the filter body includes a portion thereon through which light passes and wherein the portion has a surface area in which half of the surface area includes windows that allow light to pass there through that is not within a medium wavelength infrared wavelength range.

17. The dual band filter of claim 12, wherein the filter body includes a portion thereon through which light passes and wherein the portion has a surface area in which more than half of the surface area includes windows that allow light to pass there through that is not within a medium wavelength infrared wavelength range.

18. The dual band filter of claim 12, wherein the first set of windows only allowing light to pass there through that is within a medium wavelength infrared wavelength range only allows light that is within a threshold distance of a wavelength of a particular chemical signature.

19. The dual band filter of claim 12, wherein the first set of windows only allowing light to pass there through that is within a medium wavelength infrared wavelength range only allows light that is within a threshold distance of a wavelength of a 4400 nm.

20. The dual band filter of claim 12, wherein the first set of windows only allowing light to pass there through that is within a medium wavelength infrared wavelength range only allows light that is within a threshold distance of a wavelength of a 2700 nm.
